(19) United States
(12) Patent Application Publication
(10) Pub. No.: US 2023/0321590 A1
(43) Pub. Date: Oct. 12, 2023

(54) AQUEOUS LIQUID SORBENT

(71) Applicant: COMPACT CARBON CAPTURE AS, Bergen (NO)

(72) Inventors: Asbjørn STRAND, Bergen (NO); Dag EIMER, Bergen (NO); Øyvind TORVANGER, Nyborg (NO); Jiru YING, Porsgrunn (NO); Kari FORTHUN, Nesttun (NO)

(21) Appl. No.: 18/044,598

(22) PCT Filed: Sep. 15, 2021
(86) PCT No.: PCT/EP2021/025349

§ 371 Date: Mar. 9, 2023

(30) Foreign Application Priority Data
Sep. 17, 2020 (GB) 2014651.0

(51) Int. Cl. B01D 53/14; B01D 53/62; B01D 53/78; B01D 53/18

(52) U.S. Cl. CPC B01D 53/1493; B01D 53/1475; B01D 53/62; B01D 53/78; B01D 53/18; B01D 2252/20447; B01D 2252/20484; B01D 2257/504; B01D 2252/504

(57) ABSTRACT

An aqueous liquid sorbent suitable for use in separating a target gas from a mixture of gases in a rotating packed bed gas capture system, comprising a first amine compound, a second amine compound and water, wherein the sorbent comprises at least 16 wt % of the first amine compound and at least 51 wt % of total amine compounds, the first amine compound has a reaction rate with the target gas that is greater than the reaction rate of the second amine with the target gas, and the second amine compound has a solubility in water that is greater than the solubility of the first amine compound in water.

### FIELD OF THE INVENTION

The present invention relates to an aqueous liquid sorbent suitable for use in rotating packed bed gas capture systems, rotating packed bed gas capture systems comprising said aqueous liquid sorbent, methods for capturing gases using said aqueous liquid sorbent and the use of said aqueous liquid sorbent in carbon dioxide capture.

### BACKGROUND TO THE INVENTION

Gas capture systems are used to separate particular target gases, such as carbon dioxide or hydrogen sulphide, from mixtures of gases. For example, a gas capture system may clean a dirty gas, such as a flue gas. Carbon dioxide capture systems are also referred to as ‘carbon capture systems’.

Carbon capture and storage (CCS) is a process of capturing waste carbon dioxide from a source, such as a flue gas from a fossil fuel power plant, and then transporting and depositing it such that it will not enter the atmosphere. The primary purpose of CCS is to reduce the amount of carbon dioxide released into the atmosphere, and thereby mitigate environmental problems associated with carbon dioxide, such as global warming and ocean acidification.

Another example of the use of gas capture systems involves removing carbon dioxide from gas mixtures containing hydrogen and carbon dioxide, as may be generated by a reforming process. Reformed gas primarily contains hydrogen and commonly contains carbon dioxide, but may also contain carbon dioxide, methane, argon, nitrogen gas and perhaps other gases. Gas capture systems may reduce the concentration of carbon dioxide in such gas mixtures, and in some cases can be used to generate substantially pure hydrogen.

For post-combustion carbon dioxide capture, the present technology of choice is amine scrubbing, in which amine solutions are used to absorb the carbon dioxide from the waste gas mixture. This approach was developed in the 1920s and 30s and has advantages in terms of cost, commercial practicality, flexible implementation and the ease with which the technology can be retrofitted to existing power plants.

Aqueous solutions of monoethanolamine (MEA) are the standard sorbents used in such amine scrubbing processes, with 20 to 30 wt % solutions of MEA in water being most typical. MEA benefits from fast reaction kinetics with carbon dioxide and a high affinity for carbon dioxide even at low partial pressures, resulting in favourable cyclic capacities. Proprietary solvent blends have also been used, such as KS-1 and Econamine, although limited information is publically available on these.

Piperazine reacts rapidly with carbon dioxide, providing quick absorption, and is less resistant to thermal degradation at higher temperatures when compared to MEA. Piperazine is also resistant to oxidative degradation and non-corrosive to stainless steel. However, piperazine has limited solubility in water and the precipitation of piperazine and/or piperazine derivatives such as piperazine carbamate is a known problem under the temperatures used in carbon capture systems, particularly at higher amine concentrations. Piperazine has commonly been added to other aqueous amine solutions as an absorption accelerator. In these ‘activated amine solvents’, piperazine is typically added in amounts of 5 to 10 wt %, although mixtures containing as little as 2 wt % piperazine and as much as 15 wt % piperazine as an activator have also been described. It is a particularly well-known practice to combine small amounts of piperazine with tertiary amines, to provide faster reaction kinetics while having the low heat of reaction associated with tertiary amines.

More recently, aqueous solutions containing 40 wt % of piperazine as the only base have been proposed as an alternative sorbent for amine scrubbing, with promising results. However, the development of aqueous piperazine sorbents is hindered by the limited solubility of piperazine and the tendency of piperazine and/or its derivatives to precipitate.

In U.S. Pat. No. 4,336,233, 5 to 10 mol % of piperazine is added to 3.5 molar solutions of N-methyldiethanolamine (MDEA) or triethanolamine (TEA) and 2.5 molar solutions of diethanolamine (DEA) to provide ‘activated amine solvents’. U.S. Pat. No. 4,336,233 teaches that up to 0.8 moles per litre of piperazine can be used in such amine solvent mixtures, but that 0.2 to 0.4 moles per litre is most preferable. In particular, U.S. Pat. No. 4,336,233 teaches that it is preferable to use catalytic amounts of piperazine in conventional solvent mixtures, and states that only very dilute aqueous solutions can be used together with piperazine. Importantly, U.S. Pat. No. 4,336,233 teaches that a mixture of N-methyl-2-pyrrolidone and piperazine must include at least 60 wt % water to avoid precipitation of piperazine and/or its derivatives, and that the same broadly applies to the other solvents discussed therein. In ‘Li et al., Energy Procedia, 2013, 37, 353 to 369’, amine blends using piperazine in amounts of 8.6 to 36.5 wt % are described.

In the development of amine solutions for gas capture, it is important to balance several factors, including reaction kinetics, ease of recycling of the sorbent by releasing the absorbed gas, the viscosity of the solution under operant conditions, and the hazard of precipitation of the amine or its carbamate or other derivatives. The particular characteristics desired may vary depending on the apparatus to be used.

Typically, CCS systems involve a packed column in which, for example, flue gas is passed through and carbon dioxide is absorbed by a sorbent. These systems are very large. More recently, an alternative design of gas capture system using a rotating packed bed (RPB) for mixing a liquid sorbent and a gas has been developed. In an RPB, the mass transfer occurs in a packing that is rotated, generating an artificial gravity that is associated with an increased effective contact area between the gas and sorbent. In RPBs, higher gas velocities through the gas capture system can be achieved and the size and physical footprint of the gas capture system can therefore be reduced. Additionally, the artificial gravity generated by RPBs allows more viscous liquid sorbents to be used than in conventional CCS systems.

Aqueous solutions are typically used because of their relatively low viscosity when compared to non-aqueous solutions, which facilitates flow through the gas capture system. High flow rates and turnover of the sorbent in a gas capture system are associated with higher gas capture rates. A known issue with amine solution sorbents is the viscosity of the solution under operant conditions of gas capture systems.

In ‘Yu et al., Int. J. Greenh. Gas Con., 2013, 19, 503 to 509’, a non-aqueous sorbent solution of 40.8 wt % piperazine in diethylene glycol and its use to capture carbon dioxide in an RPB is described. The viscosity of this solution was seven times greater than the corresponding aqueous piperazine solution.

It is important for any liquid sorbent solution that the solution is stable and does not undergo precipitation of its components or otherwise become very viscous and eventually undergo solidification during use, which can disrupt the flow of the sorbent and block passageways in the system. The operant temperature of the gas capture system and the concentration of components such as amine compounds in a sorbent solution influence the propensity of the solution to undergo precipitation, increased viscosity and/or solidification. Some previously known sorbents have the disadvantage that they cannot be used at particular temperatures or concentrations without risking precipitation or solidification. It is highly advantageous for a liquid sorbent for gas capture to be stable in solution at low temperatures without risk of precipitation or solidification.

When designing a liquid sorbent for gas capture, it is critical to balance several properties such as gas capacity, reaction kinetics of the sorbent with the gas, overall gas capture rate, viscosity, volatility, and stability of the solution under operant conditions.

Rapid reaction kinetics and gas capture rates are highly desirable in carbon dioxide capture systems, and particularly in RPB systems. Importantly, faster reaction kinetics allow higher gas capture rates to be achieved without increasing the dimensions of the packing.

One challenge faced when designing a liquid sorbent is that the properties of different aqueous mixtures of amines are difficult to predict based on the behaviour of the individual amines in isolation. It is particularly difficult to predict how aqueous mixtures containing high concentrations of amines will behave under operant conditions of gas capture systems.

### SUMMARY OF THE INVENTION

It is a finding of the present invention that aqueous solutions containing a mixture of particular amines at particular concentrations have excellent properties as sorbents in gas capture systems. In particular, the inventors have found that an aqueous liquid sorbent comprising a first amine compound and a second amine compound with specific properties provides a sorbent with improved gas capture properties. The first amine compound has excellent gas capture properties, such as very fast reaction kinetics with the gas to be captured. The second amine compound has good gas capture properties, such as fast reaction kinetics with the gas to be captured, and excellent solubility in aqueous solutions.

The aqueous liquid sorbent of the present invention is particularly suitable for use in RPB carbon capture systems, and achieves excellent results in terms of carbon dioxide capture rates when used in such a system.

The sorbent of the present invention has advantages in terms of: excellent gas capture rates, particularly carbon dioxide capture rates; sufficiently low viscosity and low precipitation and solidification under typical operant conditions of gas capture systems; high capacity for captured gas, particularly carbon dioxide; low volatility; resistance to thermal degradation; and avoiding metal corrosion within the carbon capture system. Overall, the sorbent of the present invention has a desirable combination of advantageous features relating to its ability to capture gases such as carbon dioxide while overcoming known problems such as solubility limitations, precipitation and solidification, and viscosity. These properties are particularly advantageous when the sorbent of the present invention is used in an RPB carbon capture system.

In particular, the present invention provides an aqueous liquid sorbent suitable for use in separating a target gas from a mixture of gases in a rotating packed bed gas capture system, comprising a first amine compound, a second amine compound and water, wherein the sorbent comprises at least 16 wt % of the first amine compound and at least 51 wt % of total amine compounds, the first amine compound has a reaction rate with the target gas that is greater than the reaction rate of the second amine with the target gas, and the second amine compound has a solubility in water that is greater than the solubility of the first amine compound in water.

The present invention further provides: (i) a gas capture system comprising the aqueous liquid sorbent of the present invention; (ii) a method of capturing a target gas from a mixture of gases comprising bringing the mixture of gases into contact with the aqueous liquid sorbent of the present invention; and (iii) use of the aqueous liquid sorbent of the present invention for separating a target gas from a mixture of gases.

### BRIEF DESCRIPTION OF THE DRAWINGS

FIG. 1— Graph showing the carbon dioxide capture rate of different amine solvent sorbents at different sorbent flow rates in an RPB with the gas mixture and the sorbent liquid in cross-flow to each other.

FIG. 2— Photograph showing precipitation tests of different liquid amine sorbents containing piperazine and a second amine compound.

FIG. 3— Schematic diagram of the stirred cell used in Example 4.

### DETAILED DESCRIPTION OF THE INVENTION

The present invention is concerned with aqueous amine mixtures that have excellent gas capture properties. In particular, combining (a) a first amine compound that has excellent reaction kinetics for gas capture but limitations in terms of its solubility in water or tendency to precipitate under operant conditions, for example at temperatures typically used in gas capture systems, with (b) a second amine compound that has good gas capture properties and excellent solubility in water, allows high concentrations of both amine compounds to be used without the solution having problems in terms of solidification of the amines or their derivatives.

These features are particularly advantageous when the sorbent of the present invention is used in RPB carbon capture systems. RPB carbon capture systems can more easily utilise liquid sorbents with higher viscosities without experiencing the same level of difficulty typically experiences with conventional carbon capture systems. Furthermore, RPB carbon capture systems particularly benefit from the use of sorbents with rapid reaction kinetics with carbon dioxide. In particular, the contact time of the gas with the liquid sorbent can be very short in RPB carbon capture systems, such that rapid reaction kinetics are particularly advantageous. Additionally, an aqueous sorbent with faster gas reaction kinetics allows higher gas capture rates to be achieved without increasing the dimensions of the packing. As such, the sorbent of the present invention, which is able to sustain high amine concentrations in aqueous solution and has particularly excellent carbon dioxide capture rates, is particularly well suited to use in an RPB carbon capture system.

In particular, in the present invention, a first amine compound is selected which has excellent reaction kinetics for gas capture. The first amine compound may be an amine compound that has limited solubility in water, such as piperazine. The first amine compound may be an amine compound that has previously been used in relatively low concentrations in aqueous sorbent solutions, and a reason for this may be the limited solubility of this amine compound in water.

A second amine compound is selected which has good reaction kinetics for gas capture and excellent solubility in water. The second amine compound may be an amine compound that facilitates the solvation of the first amine compound in water. For example, the first amine compound may be piperazine and the second amine compound may be MEA or MDEA, which facilitate the solvation of piperazine in water.

When such a first amine compound and second amine compound are combined in an aqueous liquid sorbent, the first amine compound experiences improved solvation and retains its excellent gas reaction kinetics. The resulting aqueous liquid sorbent has excellent gas capture properties without having problems in terms of solidification of the amines or their derivatives.

The Aqueous Liquid Sorbent

The aqueous liquid sorbent of the present invention comprises a first amine compound, a second amine compound and water.

The aqueous liquid sorbent of the present invention may be prepared by mixing the first and second amine compounds in water in any order. Many suitable first amine compounds and second amine compounds are commercially available or can be prepared using methods that are well-known in the art.

The sorbent of the present invention comprises at least 51 wt % of total amine compounds. For example, if the sorbent contains the first amine compound and the second amine compound as the only amine compounds, then the amount of total amine compounds is the total amount of the first and second amine compounds combined. If the sorbent contains one or more additional amine compounds, then the amount of total amine compounds is the total amount of all amine compounds combined.

Preferably, the sorbent of the present invention comprises at least 55% of total amine compounds, more preferably at least 60% of total amine compounds, further preferably at least 65% of total amine compounds, even more preferably at least 70% of total amine compounds. Preferably, the sorbent of the present invention comprises at most 90% of total amine compounds, more preferably at most 85% of total amine compounds, further preferably at most 80% of total amine compounds, even more preferably at most 75% of total amine compounds. When the amount of amine compounds is too low, the sorbent may not achieve the same excellent gas capture rates. When the amount of amine compounds is too high, there can be solubility issues and issues with the increased viscosity and increased propensity to precipitate and/or solidify.

Preferably, the sorbent of the present invention comprises at least 22 wt % of the first amine compound, more preferably at least 25 wt % of the first amine compound, further preferably at least 30 wt % of the first amine compound, even more preferably at least 37 wt % of the first amine compound. Preferably, the sorbent of the present invention comprises at most 60 wt % of the first amine compound, more preferably at most 50 wt % of the first amine compound, further preferably at most 45 wt % of the first amine compound, and even more preferably at most 42 wt % of the first amine compound. When the amount of the first amine is too low, the sorbent may not achieve the same excellent gas capture rates. When the amount of the first amine is too high, there can be solubility issues and issues with the increased viscosity and increased propensity to precipitate and/or solidify.

Preferably, the sorbent of the present invention comprises 10 wt % to 70 wt % of the second amine compound, more preferably 15 wt % to 60 wt %, further preferably 20 wt % to 50 wt % and even more preferably 25 wt % to 45 wt %. When the amount of the second amine is too low, it may not adequately assist in solubilising the first amine compound, leading to issues with the first amine or its derivatives precipitating out of solution. Additionally, when the amount of the second amine is low, the gas capture rates of the sorbent may be decreased. When the amount of the second amine is too high, there can be issues with the high viscosity of the sorbent.

Preferably, the amount of the first amine compound in the sorbent of the present invention by wt % is greater than or equal to the amount of the second amine compound in the sorbent of the present invention by wt %. More preferably, the amount of the first amine compound in the sorbent of the present invention by wt % is greater than the amount of the second amine compound in the sorbent of the present invention by wt %. When the amount of the first amine compound is greater than the amount of the second amine compound by wt %, excellent gas capture rates can be achieved.

Preferably, the ratio of the amount of the first amine compound to the second amine compound is between 9:1 and 1:9 by wt %, preferably 3:1 to 1:3 by wt %, more preferably 2:1 to 1:1 by wt % and most preferably 3:2 to 5:4 by wt %. When the amount of the first amine compound is too high relative to the amount of the second amine compound, the second amine compound does not adequately assist in solubilising the first amine compound. When the amount of the second amine compound is too high relative to the amount of the first amine compound, a suboptimal balance between the gas capture rate and the viscosity of the sorbent is reached, wherein the sorbent has a lower gas capture rate and a higher viscosity than desired.

The wt % amounts of the first and second amine compounds present in the sorbent of the present invention enable a desirable balance of high gas capture rates with improved solubility and viscosity properties, stability of solution, and reduction in precipitation of the amine compounds or their derivatives at temperatures and other operant conditions typical of gas capture systems.

Preferably, the sorbent of the present invention captures at least 30% of the carbon dioxide present in a feed when used in a rotating packed bed carbon capture system with an internal diameter of 0.1 m, an outer diameter of 0.3 m and an axial length of 0.1 m, rotated at 820 rpm with the gas mixture and the liquid sorbent in cross-flow with a sorbent flow rate of 5 litres per minute and gas flow rate of 360 kg/h at 40° C.

Preferably, the first amine compound and the second amine compound present in the sorbent of the present invention are stable in solution in the sorbent at temperatures of 40° C. and higher, more preferably at temperatures of 30° C. and higher, even more preferably at temperatures of 20° C. and higher, further preferably at temperatures of 10° C. and higher, and more preferably still at temperatures of 5° C. and higher. In this context, “stable in solution” means that the amine compounds or their derivatives do not precipitate out of solution or otherwise solidify in the solution.

The number of moles of amine compounds in a solution is the total number of moles of all amine species present in the solution. For example, a solution containing 1 mole of piperazine and 1 mole of MEA contains 2 moles of amine compounds.

First Amine Compound

The first amine compound of the sorbent of the present invention is an amine compound that has a greater reaction rate with the target gas to be captured than the reaction rate of the second amine compound of the sorbent with the target gas. That is to say:

rate(first amine+gas)>rate(second amine+gas)

Wherein “rate(first amine+gas)” is the reaction rate of the first amine compound with the target gas to be captured and “rate(second amine+gas)” is the reaction rate of the second amine compound with the target gas to be captured.

Preferably, the first amine compound has very rapid reaction kinetics with the target gas. This enables the sorbent of the present invention to achieve very high gas capture rates.

The reaction rate of the first or second amine compound with the target gas is preferably measured at a temperature of 40 to 60° C. More preferably, the reaction rate is measured at a temperature of 40 to 60° C., a target gas loading of 0 to 0.5 moles of gas per mole of amine compound (mol/mol amine), and an amine concentration in water of 20 to 50 wt %. Further preferably, the reaction rate is measured at a temperature of 60° C., a target gas loading of 0.2 mol/mol amine, and an amine concentration in water of 40 wt %. That is to say, the reaction rate of an amine compound with a target gas is preferably measured based on a 40 wt % solution of the amine in water with a target gas loading level of 0.2 mol/mol amine and at a temperature of 60° C.

The reaction rate may be assessed by measuring the average liquid film mass transfer coefficient at a temperature of 40° C. (k′_{g,avg}×10⁷ @ 40° C.). The first amine compound preferably has a reaction rate with the target gas, as assessed by measuring the k′_{g,avg}×10⁷ @ 40° C., of at least 5.0 mol/s Pa m², preferably at least 6.0 mol/s Pa m², more preferably at least 7.0 mol/s Pa m² and even more preferably at least 8.0 mol/s Pa m². When the first amine compound has such reaction rates with the target gas, the resulting sorbent may have very high gas capture rates.

The reaction rate may alternatively be assessed by measuring the reaction rate constant. The first amine compound preferably has a reaction rate with the target gas, as assessed by measuring the reaction rate constant at 25° C., of at least 10000 m³ kmol⁻¹ s⁻¹, preferably at least 25000 m³ kmol⁻¹ s⁻¹, more preferably at least 40000 m³ kmol⁻¹ s⁻¹, and even more preferably at least 50000 m³ kmol⁻¹ s⁻¹. When the first amine compound has such reaction rates with the target gas, the resulting sorbent may have very high gas capture rates. Literature reaction rate constants at 25° C. for a selection of amines are set out in Table 1.

TABLE 1
amine reaction rate constants at 25° C.

| | Reaction rate constant |
|---|---|
| Amine | at 25° C. (m³kmol⁻¹s⁻¹) |
| Monoethanolamine (MEA) | 7000 |
| Diglycolamine (DGA) | 6663 |
| Diethanolamine (DEA) | 2375 |
| Piperazine | 53700 |
| Diisopropanolamine (DIPA) | 2585 |
| N-methyldiethanolamine | 18 |
| (MDEA) | |
| 2-amino-2-methyl-1-propanol | 810 |
| (AMP) | |

Preferably, the first amine compound is piperazine or a derivative of piperazine. More preferably, the first amine compound is selected from piperazine, 2-methyl piperazine, N-methyl piperazine, N,N-dimethyl piperazine, hydroxylethylpiperazine, hydroxyisopropylpiperazine and (piperazinyl-1)-2-ethylamine, further preferably from piperazine, 2-methyl piperazine, N-methyl piperazine and N,N-dimethyl piperazine. Most preferably, the first amine compound is piperazine.

When the first amine compound is one of the above-mentioned compounds, excellent gas capture properties can be achieved. In particular, very high carbon dioxide capture rates can be achieved.

Second Amine Compound

The second amine compound has a solubility in water that is greater than the solubility of the first amine compound in water. That is to say:

solublity(second amine)>solubility(first amine)

Wherein “solublity(second amine)” is the solubility of the first amine compound in water and “solubility(first amine)” is the solubility of the second amine compound in water. Preferably, the second amine compound has very high solubility in water. This means that the amount of the amine compound that is stable in solution in a litre of water is high. For example, at temperatures at which the amine compound is a solid, the amount of the amine compound that may be fully dissolved in a litre of water is high. Similarly, at temperatures at which the amine compound is a liquid, the amount of the amine compound that is fully miscible in a litre of water is high.

It is also preferable that the second amine compound is highly compatible with the first amine compound. That is, at temperatures at which both amine compounds are liquid, they are preferably highly miscible, and at temperatures at which one amine compound is a liquid and the other is a solid, the amount of the solid amine compound that may be fully dissolved in the liquid amine compound is high.

Preferably, the first amine compound and the second amine compound are miscible, or the first amine compound is soluble in the second amine compound, or the second amine compound is soluble in the first amine compound.

When the second amine has sufficiently high solubility in water and is sufficiently compatible with the first amine compound, it facilitates the solvation of the first amine compound in water and the sorbent of the present invention exhibits excellent stability as a solution and does not experience precipitation of the amine compounds or their derivatives or otherwise undergoes solidification, even at very low temperatures, and also at low gas loadings.

When the solubility of the second amine compound in water is too low, it may not sufficiently facilitate the solvation of the first amine compound and the resulting sorbent may not be a stable solution under conditions characteristic of gas capture systems. When the compatibility of the first and second amine compounds is too low, the second amine compound may not sufficiently facilitate the solvation of the first amine compound and the resulting sorbent may not be a stable solution under conditions characteristic of gas capture systems.

Preferably, the first amine compound has a solubility in the aqueous liquid sorbent that is greater than the solubility of the first amine compound in water. If the aqueous liquid sorbent comprises components other than the first amine compound and second amine compound, the first amine compound preferably has a solubility in the aqueous liquid sorbent that is greater than the solubility of the first amine compound in a corresponding solution in which the second amine compound has been replaced with water.

The solubility of the first or second amine compound in water may be represented by the number of grams of the amine compound that is fully soluble in a litre of water at room temperature. These values may be assessed using experimental data, for example by carrying out a titration experiment, or by predictive calculation based on its chemical structure using the ALOGPS 2.1 program. Preferably, these values are as assessed using the ALOGPS 2.1 program.

The second amine compound of the present invention preferably has a solubility in water at room temperature of at least 400 g/L, preferably at least 500 g/L, more preferably at least 600 g/L, even more preferably at least 700 g/L and most preferably at least 800 g/L. Preferably, these values are as assessed using the ALOGPS 2.1 program.

The second amine compound preferably has a hydrophilicity that allows it to mix freely with water and be highly soluble in water, but also mix freely with the first amine compound, thereby allowing it to facilitate solvation of the first amine compound in water.

The hydrophilicity of an amine compound can be measured as the log P value, wherein P is the partition coefficient of the compound between n-octanol and water. The log P value may be assessed using experimental data collected using methods well known in the art or by predictive calculation based on its chemical structure using the ALOGPS 2.1 program. Preferably, the log P value is as assessed using the ALOGPS 2.1 program.

The second amine compound of the present invention preferably has a log P value of from −2.5 to −0.9, preferably from −2.0 to −1.0, more preferably from −1.8 to −1.2, and further preferably from −1.6 to −1.4. Preferably, these log P values are as assessed using the ALOGPS 2.1 program. When the log P value of the second amine compound is too low (e.g. too negative), it may not mix well with the first amine compound and the first amine compound may not be fully soluble in the resulting sorbent. When the log P value of the second amine compound is too high (e.g. less negative), it may not mix well with water and the second amine compound may not be fully soluble in the resulting sorbent.

Furthermore, it is preferable for the second amine compound to have fast reaction kinetics with the target gas to be captured by the sorbent of the present invention. In combination with the choice of the first amine compound, the use of a second amine compound with fast reaction kinetics with the target gas enables the sorbent of the present invention to achieve extremely high gas capture rates.

The second amine compound preferably has a reaction rate with the target gas, as assessed by measuring the k′_{g,avg}×10⁷ @ 40° C., of at least 3.0 mol/s Pa m², more preferably at least 3.5 mol/s Pa m² and even more preferably at least 4.0 mol/s Pa m². When the second amine compound has such reaction rates with the target gas, the resulting sorbent may have very high gas capture rates.

Preferably, the second amine compound is an alkanolamine. More preferably, the second amine compound is a primary or a secondary alkanolamine, even more preferably a primary alkanolamine. This means that the alkanolamine includes at least one primary amine group. Primary alkanolamines typically have more rapid gas capture rates than secondary alkanolamines, which typically have more rapid gas capture rates than tertiary alkanolamines. However, this is only a general trend, and tertiary alkanolamines may have, for example, high cyclic capacity for capturing gases such as carbon dioxide and thus have desirable properties as a second amine compound of the present invention. For example, MDEA has excellent cyclic capacity for capturing gases such as carbon dioxide.

Preferably, the second amine compound is an alkanolamine selected from monoethanolamine, diethanolamine, triethanolamine, N-methylmonoethanolamine, N-methyldiethanolamine, N,N-dimethylmonoethanolamine, N,N-diethylmonoethanolamine, monoisopropanolamine, diisopropanolamine, N-methyldiisopropanolamine, 3-aminopropanol, 2-amino-2-methyl-1-propanol, 2-(2-aminoethylamino)ethanol and diglycolamine, further preferably selected from monoethanolamine, diethanolamine, N-methylmonoethanolamine, N-methyldiethanolamine, monoisopropanolamine, diisopropanolamine, 3-aminopropanol, 2-amino-2-methyl-1-propanol, 2-(2-aminoethylamino)ethanol and diglycolamine. Most preferably, the second amine compound is monoethanolamine or N-methyldiethanolamine.

The second amine compound may also be a non-alcoholic amine such as diethylenetriamine.

When the second amine compound is one of the above-mentioned compounds, the sorbent of the present invention has excellent solution stability and gas capture properties. In particular, high stability at low temperatures and high carbon dioxide capture rates can be achieved.

Additives

The aqueous liquid sorbent of the present invention primarily comprises the first amine compound, the second amine compound and water. However, the sorbent may also comprise any additives typical of aqueous liquid sorbent additives, such as antifoaming agents, corrosion inhibitors and oxidation preventers. Antifoaming agents include, for example, polydimethylsiloxane (PDMS) based antifoaming agents and high carbon alcohol (C₇ to C₉) based antifoaming agents. Corrosion inhibitors include, for example, molybdates and chromates. Such additives may be included in the aqueous liquid sorbent of the present invention as needed or desired. For example, the aqueous liquid sorbent of the present invention may comprise one or more polydimethylsiloxane (PDMS) based antifoaming agents.

The Target Gas

The aqueous liquid sorbent of the present invention is suitable for use in separating one or more target gases from a mixture of gases. The target gas is also referred to herein as “the gas to be captured”. The target gas is preferably carbon dioxide or hydrogen sulphide, more preferably carbon dioxide. The sorbent of the present invention achieves excellent gas capture rates when the target gas is carbon dioxide.

The Gas Capture System

The sorbent of the present invention is suitable for use in a gas capture system that comprises the sorbent of the present invention, such as an RPB gas capture system that comprises the sorbent of the present invention. The present invention provides a gas capture system comprising the aqueous liquid sorbent of the present invention.

Preferably, the gas capture system is a system for capturing carbon dioxide or hydrogen sulphide. More preferably, the gas capture system is a system for capturing carbon dioxide, e.g. a carbon dioxide capture system or a ‘carbon capture system’. Even more preferably, the gas capture system is post-combustion carbon dioxide capture system or a system for carbon dioxide capture from a mixture of gases comprising hydrogen and carbon dioxide. The mixture of gases comprising hydrogen and carbon dioxide may be reformed gas and may further comprise other gases such as methane, argon and nitrogen gas, amongst others.

The sorbent of the present invention is particularly suitable for use in CCS because the amines present in the sorbent are excellent carbon dioxide absorbers and the sorbent of the present invention has excellent carbon dioxide capture properties such as a high carbon dioxide absorption rate.

Preferably, the gas capture system is an RPB gas capture system. More preferably, the gas capture system is an RPB carbon dioxide capture system.

RPB gas capture systems benefit from high reaction rates and absorption rates between the sorbent and the target gas, and have a higher tolerance of more viscous liquid sorbents than conventional gas capture systems. The sorbent of the present invention is able to achieve and sustain high amine concentrations under conditions typical of gas capture systems, and this results in the sorbent of the present invention having relatively higher viscosity than a solution containing lower concentrations of similar amines would have. This high amine concentration, in combination with the choice of amines present in the sorbent, allows the sorbent of the present invention to achieve exceptionally high reaction rates and absorption rates with target gases, and especially with carbon dioxide. Therefore, the sorbent of the present invention is particularly well suited for use in an RPB gas capture system.

Recently, improved RPB designs have been developed. For example, WO 2019/057932 describes RPBs having a central chamber receiving a flow of a liquid sorbent and a flow path for the sorbent between the central chamber and a region for mass transfer between a gas and the sorbent, wherein, when the RPB is in use, the flow of sorbent through the region for mass transfer is substantially in cross-flow with the flow of gas through the region for mass transfer. The entirety of WO 2019/057932 is hereby incorporated by reference.

Methods and Uses

The present invention also provides a method of capturing a target gas from a mixture of gases comprising bringing the mixture of gases into contact with the aqueous liquid sorbent of the present invention. This method of the present invention preferably comprises bringing the mixture of gases into contact with the aqueous liquid sorbent using a gas capture system. Preferably, the gas capture system is a RPB gas capture system. Further preferably, the RPB gas capture system has a region for mass transfer and is configured such that the flow of sorbent through the region for mass transfer is substantially in cross-flow with the flow of gas through the region for mass transfer. This minimises pressure drop when compared with counter-current flow configurations. Preferably, the target gas is carbon dioxide.

When such methods are used to capture a target gas from a mixture of gases, and particularly when such methods are used to capture carbon dioxide, excellent gas capture rates can be achieved.

The present invention also provides use of the aqueous liquid sorbent of the present invention for separating a target gas from a mixture of gases. Preferably, the target gas is separated from a mixture of gases in a gas capture system that comprises the aqueous liquid sorbent, and more preferably the target gas is separated from a mixture of gases in a rotating packed bed gas capture system that comprises the aqueous liquid sorbent. Preferably, the target gas is carbon dioxide, and more preferably the use is: (i) post-combustion carbon dioxide capture; or (ii) carbon dioxide capture from a mixture of gases comprising hydrogen and carbon dioxide. The mixture of gases comprising hydrogen and carbon dioxide may be reformed gas and may further comprise other gases such as methane, argon and nitrogen gas, amongst others.

This is a suitable use of the aqueous liquid of the present invention due to the excellent gas capture rates that can be achieved, and in particular the excellent carbon dioxide capture rates that can be achieved.

### EXAMPLES

The following are Examples that illustrate the present invention. However, these Examples are in no way intended to limit the scope of the invention.

### Example 1: Carbon Dioxide Capture of Aqueous Liquid Sorbents from an Artificial Flue Gas

Sorbents were prepared using commercially available components as set out in Table 2.

TABLE 2
sorbent compositions

| | Amount of | | Carbon dioxide |
|---|---|---|---|
| | piperazine | Amount of | loading |
| Name | (wt %) | MEA (wt %) | (mol/mol amine) |
| MEA30 | 0 | 30 | 0 |
| MEA70 | 0 | 30 | 0 |
| MEA70 (CO₂) | 0 | 70 | 0.2 |
| PZ30 | 30 | 0 | 0 |
| PZ40/MEA30 | 40 | 30 | 0 |
| PZ40/MEA30 | 40 | 30 | 0.2 |
| (CO₂) | | | |

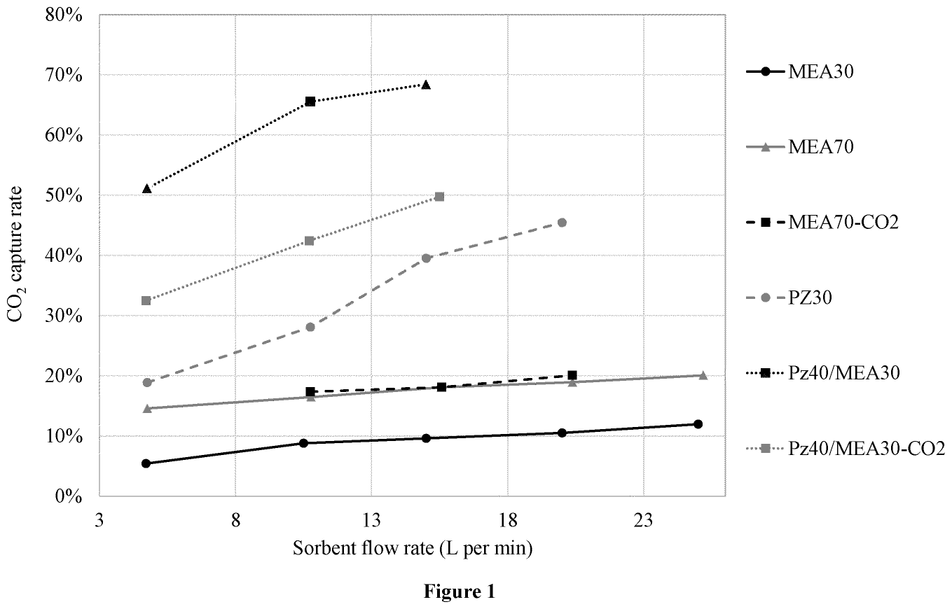

The ability of these sorbents to absorb carbon dioxide was tested by loading them into an RPB carbon dioxide capture apparatus, feeding gas containing carbon dioxide into the apparatus, and measuring the carbon dioxide capture rate of the sorbent at different sorbent flow rates. The RPB had an internal diameter of 0.1 m, and outer diameter of 0.3 m and an axial length of 0.1 m. It was rotated at 820 rpm and the gas and the liquid were configured in cross-flow. The CO₂ concentration in the gas phase was 1 mol %, the gas flow was 360 kg/h, and the temperature was 40° C. The results are shown in FIG. 1.

It can be seen from the results that the mixture of 40 wt % piperazine and 30 wt % MEA captures a markedly higher proportion of the carbon dioxide in the gas feed and thus can be seen to achieve markedly higher carbon dioxide capture rates than the other amine solutions tested, even at moderate carbon dioxide loadings.

### Example 2: Carbon Dioxide Capture of Aqueous Liquid Sorbents from a Real Flue Gas

An aqueous sorbent solution containing 40 wt % of piperazine, 30 wt % of MEA and 30 wt % of water was prepared. The ability of this solution to absorb carbon dioxide from a real flue gas was tested in a waste energy plant using the same RPB carbon dioxide capture apparatus as in Example 1. The components of the real flue gas (excluding nitrogen gas) are shown in Table 3.

TABLE 3
main components of the real flue gas

| O₂ | H₂O | CO | Ash | NOₓ | SO₂ | TOC | CO₂ |
|---|---|---|---|---|---|---|---|
| (Vol %) | (Vol %) | (mg/Nm³) | (mg/Nm³) | (mg/Nm³) | (mg/Nm³) | (mg/Nm³) | (Vol %) |
| 8.71 | 18.17 | 13.95 | 0.75 | 99.16 | 0.20 | 0.72 | 8.72 |

This real flue gas, containing about 8.72 vol % carbon dioxide, was fed into the RPB carbon dioxide capture apparatus. The prepared piperazine/MEA aqueous sorbent solution was loaded into the apparatus and the ability of the solution to absorb carbon dioxide at different sorbent flow rates was measured. The RPB had an internal diameter of 0.1 m, an outer diameter of 0.3 m and an axial length of 0.1 m. It was rotated at 820 rpm and the gas and the liquid were configured in cross-flow. The gas flow was in the range of 150 to 360 kg/h and an operating temperature of 40-55° C. was used. A sorbent flow rate of 5 to 20 litres per minute was used.

Between 45% to 75% of the carbon dioxide was captured at different liquid sorbent flow rates. These results are consistent with those obtained in Example 1.

### Example 3: Precipitation of Aqueous Liquid Sorbents Containing Piperazine

Aqueous liquid sorbents were prepared containing piperazine as the first amine compound and either MEA or MDEA as the second amine compound. For each of the two second amine compounds, twelve different mixtures containing different amounts of piperazine and the second amine compound were prepared, as set out in Table 4.

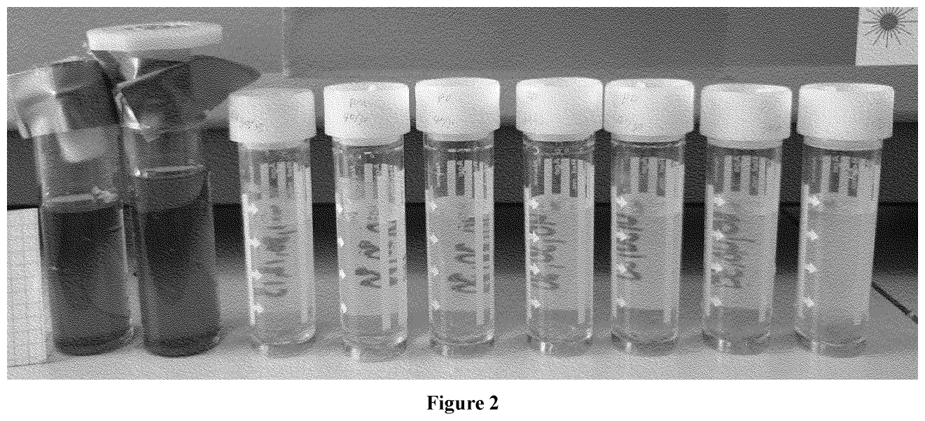

For each of the twenty four different sorbent mixtures, four samples were placed into 10 to 20 mL containers. Two of these samples were immersed in a 20° C. water bath, and two samples were placed in a fridge at 5° C. These samples were maintained at these temperatures for at least twenty four hours and then observed for precipitation. FIG. 2 shows the appearance of some of these samples following this experiment.

TABLE 4
aqueous liquid sorbents containing piperazine

| Piperazine | Second amine |
|---|---|
| conc. (wt %) | conc. (wt %) |
| 10 | 60 |
| 20 | 50 |
| 30 | 40 |
| 35 | 35 |
| 40 | 30 |
| 50 | 20 |
| 50 | 25 |
| 50 | 30 |
| 55 | 15 |
| 55 | 20 |
| 65 | 10 |
| 65 | 20 |

### Example 4: Absorption Rates of Aqueous Liquid Sorbents at Different Carbon Dioxide Loadings

A further series of sorbents was prepared using commercially available components, as described in Table 5. The specified amounts of amine were combined with water to give aqueous solutions of the stated amine concentrations. The ability of these sorbents to absorb carbon dioxide at different loading levels of carbon dioxide was then tested.

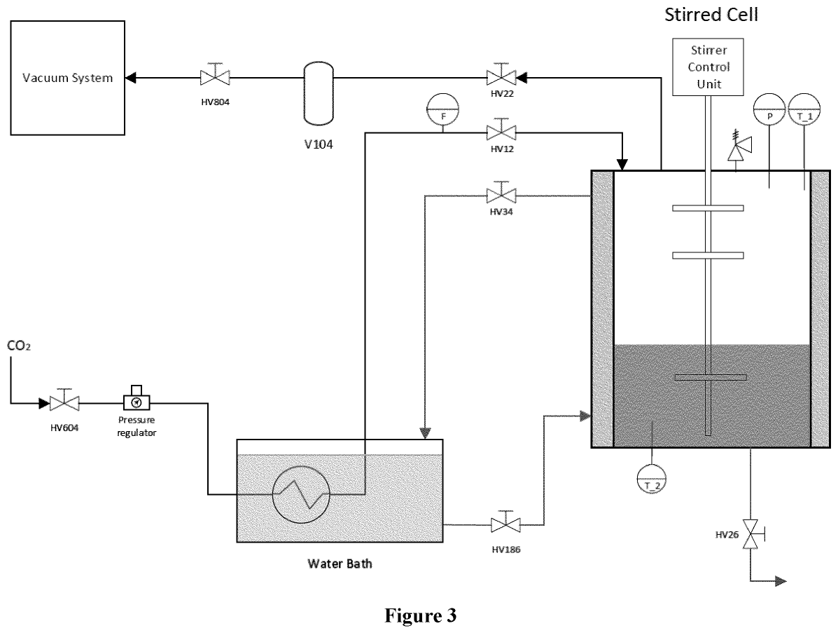

A stirred cell apparatus was set up as shown in FIG. 3. The stirred cell was an absorber reactor having a glass cell with an inside diameter of 9.5 cm, enclosed in a water jacket. A rotating shaft was installed in the centre of the cell, with two gas stirrers and one liquid stirrer mounted on the same shaft, to ensure uniform mixing. To maintain a smooth surface of the liquid, eight baffles were installed in the bottom of the stirred cell.

The stirred cell was operated as a semi-batch reactor. The volume of the reactor volume 13.5 cm², the operational pressure used was 1800 mbar, the vacuum pressure used was 200 mbar. the temperature used was 40° C. and the stirring speed used was 500 rpm.

For each experiment, 280 g of freshly prepared solution was fed into the cell using a vacuum pump. The stirrer was turned off, to limit the amount of carbon dioxide absorbed before the cell is filled with carbon dioxide. The cell was then vacuumed before introducing carbon dioxide. As soon as the target pressure was reached, stirring was started and absorption of carbon dioxide was measured. The results of these experiments are shown in Table 5.

From these results, it can be seen that sorbent solutions of the present invention achieve excellent carbon dioxide absorption rates. It can also be seen that piperazine/MDEA solutions have higher absorption rates at low carbon dioxide loadings when compared with piperazine/MEA solutions. This is true for carbon dioxide loadings of around 0.25 mol/mol amine and lower. At higher carbon dioxide loadings, the solutions have similar absorption rates. Thus, piperazine/MDEA solutions have faster reaction kinetics with carbon dioxide at a wider range of carbon dioxide loading levels.

TABLE 5
absorption rates of aqueous liquid sorbents at different carbon dioxide loadings

| Amount of | Amount of | Amount of | Absorption rate (L/min) | | | | | | |
|---|---|---|---|---|---|---|---|---|---|
| piperazine | MEA | MDEA | at specified carbon dioxide loading (mol/mol amine) | | | | | | |
| (wt %) | (wt %) | (wt %) | 0.1 | 0.2 | 0.3 | 0.4 | 0.5 | 0.6 | 0.7 |
| 0 | 30 | 0 | 1.689 | 1.148 | 0.698 | 0.497 | 0.174 | | |
| 0 | 70 | 0 | 4.449 | 2.714 | 1.445 | 0.634 | | | |
| 10 | 60 | 0 | 6.217 | 4.210 | 2.635 | 1.353 | 0.267 | | |
| 30 | 40 | 0 | 8.774 | 5.257 | 3.165 | 1.947 | 0.888 | 0.132 | |
| 40 | 30 | 0 | 9/463 | 6.186 | 4.067 | 2.581 | 1.321 | 0.356 | |
| 0 | 0 | 70 | 0.248 | 0.207 | | | | | |
| 10 | 0 | 60 | 4.893 | 2.961 | 0.984 | 0.532 | 0.206 | | |
| 30 | 0 | 40 | 11.413 | 8.904 | 3.082 | 1.804 | 1.611 | 0.382 | |
| 40 | 0 | 30 | 12.283 | 7.431 | 3.888 | 2.657 | 1.548 | 0.700 | 0.248 |

1. An aqueous liquid sorbent suitable for use in separating a target gas from a mixture of gases in a rotating packed bed gas capture system, comprising a first amine compound, a second amine compound and water, wherein:
the sorbent comprises at least 16 wt % of the first amine compound;
the sorbent comprises at least 51 wt % of total amine compounds;
the first amine compound has a reaction rate with the target gas that is greater than the reaction rate of the second amine with the target gas; and
the second amine compound has a solubility in water that is greater than the solubility of the first amine compound in water.

2. The aqueous liquid sorbent of claim 1, wherein the first amine compound has a solubility in the aqueous liquid sorbent that is greater than the solubility of the first amine compound in water.

3. The aqueous liquid sorbent of claim 1, wherein: the first amine compound and the second amine compound are miscible; the first amine compound is soluble in the second amine compound; or the second amine compound is soluble in the first amine compound.

4. The aqueous liquid sorbent of claim 1, wherein the target gas is carbon dioxide or hydrogen sulphide, preferably carbon dioxide.

5. The aqueous liquid sorbent of claim 1, wherein the sorbent comprises from 55% to 90% of total amine compounds, preferably at from 60% to 85% of total amine compounds, more preferably from 65% to 80% of total amine compounds, further preferably 70% to 75% of total amine compounds.

6. The aqueous liquid sorbent of claim 1, wherein the sorbent comprises from 22 wt % to 60 wt % of the first amine compound, preferably from 25 wt % to 50 wt % of the first amine, more preferably from 30 wt % to 45 wt % of the first amine compound and most preferably from 37 wt % to 42 wt % of the first amine compound.

7. The aqueous liquid sorbent of claim 1, wherein the sorbent comprises from 10 wt % to 80 wt % of the second amine compound, preferably from 15 wt % to 70 wt % of the second amine compound, more preferably from 20 wt % to 60 wt % of the second amine compound and most preferably from 25 wt % to 50 wt % of the second amine compound.

8. The aqueous liquid sorbent of claim 1, wherein the sorbent comprises the first amine compound and the second amine compound in a ratio of from 9:1 to 1:9 by wt %, preferably from 3:1 to 1:3 by wt %, more preferably from 2:1 to 1:1 by wt % and most preferably from 3:2 to 5:4 by wt %.

9. The aqueous liquid sorbent of claim 1, wherein the reaction rate of the first amine compound with the target gas and the reaction rate of the second amine with the target gas are both measured at a temperature of 40 to 60° C.,
preferably measured at a temperature of 40 to 60° C., a target gas loading of 0 to 0.5 moles of gas per mole of amine compound, and an amine concentration in water of 20 to 50 wt %,
more preferably measured at a temperature of 60° C., a target gas loading of 0.2 moles of gas per mole of amine compound, and an amine concentration in water of 40 wt %.

10. The aqueous liquid sorbent of claim 1, wherein the first amine compound is piperazine or a derivative thereof,
preferably wherein the first amine compound is selected from piperazine, 2-methyl piperazine, N-methyl piperazine, N,N-dimethyl piperazine, hydroxylethylpiperazine, hydroxyisopropylpiperazine and (piperazinyl-1)-2-ethylamine,
further preferably wherein the first amine compound is selected from piperazine, 2-methyl piperazine, N-methyl piperazine and N,N-dimethyl piperazine, and
most preferably wherein the first amine compound is piperazine.

11. The aqueous liquid sorbent of claim 1, wherein the second amine compound is an alkanolamine, preferably selected from monoethanolamine, diethanolamine, triethanolamine, N-methylmonoethanolamine, N-methyl diethanolamine, N,N-dimethylmonoethanolamine, N,N-diethylmonoethanolamine, monoisopropanolamine, diisopropanolamine, N-methyldiisopropanolamine, 3-aminopropanol, 2-amino-2-methyl-1-propanol, 2-(2-aminoethylamino)ethanol and diglycolamine,
preferably wherein the second amine compound is selected from monoethanolamine, diethanolamine, N-methylmonoethanolamine, N-methyldiethanolamine, monoisopropanolamine, diisopropanolamine, 3-aminopropanol, 2-amino-2-methyl-1-propanol, 2-(2-aminoethylamino)ethanol and diglycolamine,
more preferably wherein the second amine compound is monoethanolamine or N-methyldiethanolamine, and
most preferably wherein the second amine compound is monoethanolamine.

12. The aqueous liquid sorbent of claim 1, wherein the first amine compound and the second amine compound are stable in solution in the aqueous liquid sorbent at temperatures of 40° C. and higher, more preferably at temperatures of 30° C. and higher, even more preferably at temperatures of 20° C. and higher, further preferably at temperatures of 10° C. and higher, and most preferably at temperatures of 5° C. and higher.

13. A gas capture system comprising the aqueous liquid sorbent of claim 1.

14. The gas capture system of claim 13, wherein the gas capture system is a carbon dioxide capture system, preferably a post-combustion carbon dioxide capture system or a system for carbon dioxide capture from a mixture of gases comprising hydrogen and carbon dioxide.

15. The gas capture system of claim 13, wherein the gas capture system is a rotating packed bed gas capture system, preferably a rotating packed bed carbon dioxide capture system.

16. A method of capturing a target gas from a mixture of gases comprising bringing the mixture of gases into contact with the aqueous liquid sorbent of claim 1, preferably comprising bringing the mixture of gases into contact with the aqueous liquid sorbent using a gas capture system, and more preferably comprising bringing the mixture of gases into contact with the aqueous liquid sorbent using a rotating packed bed gas capture system.

17. The method of claim 16, wherein the target gas is carbon dioxide.

18. Use of an aqueous liquid sorbent as defined in claim 1 for separating a target gas from a mixture of gases.

19. The use of claim 18, wherein the target gas is separated from a mixture of gases in a gas capture system that comprises the aqueous liquid sorbent, preferably in a rotating packed bed gas capture system that comprises the aqueous liquid sorbent.

20. The use of claim 18, wherein the target gas is carbon dioxide, and preferably wherein the use is: (i) post-combustion carbon dioxide capture; or (ii) carbon dioxide capture from a mixture of gases comprising hydrogen and carbon dioxide.
